(19) United States
(12) Patent Application Publication
(10) Pub. No.: US 2005/0260370 A1
(43) Pub. Date: Nov. 24, 2005

(54) Method for producing heat-set base of a plastic container

(75) Inventors: Greg Trude, Seven Valleys, PA (US); John Tobias, Spartanburg, SC (US); Adam Coffman, Dover, PA (US); Robert A. Stewart, York, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 10/851,086

(22) Filed: May 24, 2004

(51) Int. Cl. B29C 49/06

(52) U.S. Cl. 428/35.7; 264/537; 264/525; 264/235

(57) ABSTRACT

A method for making a blow molded plastic container that can withstand the rigors of pasteurization of retort processing. The method includes introducing an injection molded plastic preform into a blow mold; circulating heated oil through the sidewall mold halves at a temperature of at least about 225° F. and circulating heated oil through the base push up at a temperature of at least about 275° F. The container is blow molded from the preform and heat set within the mold. The container has enhanced crystallinity in the base as compared to when heated water is circulated through the mold.

### BACKGROUND OF THE INVENTION

1. Field of the Invention

The present invention relates to a method for producing a heat-set base in a blow-molded plastic container during the molding process. More particularly, the present invention is directed towards a method for producing a heat-set base by heating the push up mold using oil.

2. Related Art

The use of plastic containers for packaging liquid products such as juices has become commonplace in recent years. Many such products are packaged using a hot-fill process. In a hot-fill process, heated liquid is added to a molded container at about 182° F. The container is then capped and allowed to cool. During the cooling process, the liquid and gaseous contents of the container contract, resulting in a decrease in the internal pressure and volume of the container. This decrease in pressure and volume can cause the container to deform. For example, the container sidewalls and dome can collapse inwardly, causing a cylindrical container to become oval. In extreme cases, the finish, where a closure would attach, can be pulled downward toward the container.

In order to accommodate the forces associated with this reduction in pressure and volume, and to prevent deformation of the container, various design features can be incorporated into a container. For example, ribs and other structural features are incorporated into the sidewall and dome in order to prevent distortion. These features operate by adding rigidity. As an alternative to adding rigidity to prevent deformation, features in the container may be designed to move in response to pressure and volume changes. For example, thin walled regions may be present and designed with specific geometries that are able to move in and out in response to pressure and volume changes. In addition, particularly in the sidewalls, there may be vacuum relief panels which flex inwardly in a controlled manner to accommodate the changes in volume and pressure.

While deformation by ovalization is the primary problem that can occur in the container sidewall and dome, deformation of the base is manifest in different ways. For example, as the base moves in response to the reduction in pressure and volume, the level surface on which the container sits can be distorted, resulting in a container that sits at an angle. Additionally, as the base responds to volume changes, the center of the base can bulge out, so that the base no longer sits evenly on a flat surface, but wobbles on the rounded bulging portions. This phenomenon is known as “roll out”. Additional features may be incorporated into the container base to alleviate these problems. The most common structural change in a base is the use of a ribbed base push up. Base push ups are generally an indented central portion of the base and usually contain several ribs. The base push up resists deformation in several ways. First, as they do in a container sidewall, the ribs create rigidity that prevents deformation. Additionally, particularly with polyethylene terephthalate (PET) containers, the formation of ribs by stretching and forming during the blow molding process induces biaxial orientation of the normally amorphous plastic. This increase in orientation is manifest as an increase in crystallinity of the plastic in the base. As biaxial orientation and crystallinity increase, the plastic becomes more rigid and, therefore, more resistant to deformation.

Such design features are well-known in the art, although container manufacturers strive to make further improvements to maintain the structural integrity of the containers and accommodate volumetric and pressure changes.

Unlike liquid products such as juices, other products, particularly solid or semi-solid products such as pickles and sauerkraut, are processed using different methods. Typically, these products are processed by pasteurization and retort processes. Using these processes, a product can be packed into the container along with a liquid at a temperature less than 82° C. (180° F.) or the product placed in the container that is then filled with liquid, which may have been previously heated. Pasteurization and retort differ from hot-fill processing by heating the contents of the filled and capped container to a specified temperature, after the container is filled and capped. Typically the filled container is heated to a temperature greater than 93° C. (200° F.). In pasteurization processes, temperatures can approach the boiling point of water and, in retort processes, where an overpressure is applied, the temperature can exceed the boiling point of water. Heating is continued until the contents reach a specified temperature, referred to as the called the Center Can Temperature or core temperature, for a predetermined length of time. Typical target core temperatures can be, for example, about 70-80° C. (155-175° F.) and the length of time at the core temperature can be about 20-60 minutes.

Use of a plastic container for food products packaged using pasteurization or retort processing present several additional challenges to the container manufacturer and designers. For example, the temperatures encountered by the container during pasteurization or retort processing can be higher than the temperatures encountered during hot-fill processing. These temperatures, which can approach 212° F., can approach or even exceed the glass transition temperature (T_{g}) of the plastic material used to manufacture the container. For example, the T_{g} of of amorphous polyethylene terephthalate (PET) is 153° F. Depending on the level of crystallinity and orientation achieved through processing in a heat-set mold, this value can be as high as approximately 250° F. in the container sidewalls. However, due to the lack of stretch and lower base pushup mold temps, the base region will have a glass transition temperature somewhere between these two values. The increased temps, coupled with the internal positive pressures unique to pasteurization, can cause the base to roll out if the T_{g} of the material in the base isn't sufficiently high. Increasing the heat set temperature in the base push up raises the T_{g} of the unstretched material near the center of the base pushup, thereby making it more resistant to rollout at the elevated temperatures and pressures incurred during pasteurization.

In addition, the pressure changes induced during pasteurization or retort processing differ from those of hot-fill processing in that, rather than simply a volumetric reduction occurring, there is an increase in the internal pressure developed in the capped and heated container. Because the container is heated after filling and capping, the container must resist not only vacuum or sub-baric pressures and reductions in volume within the container, but must also withstand higher or superbaric pressures and increases in volume. In spite of these differences in demands, plastic containers designed for use in pasteurization and retort processing typically utilize vacuum absorption panels similar to those in hot-fill containers in order to accommodate pressure and volume changes as the sealed container is heated and/or as the contents cool within the sealed container.

The container design may be modified to accommodate these additional pressure and volume changes by, for example, using thicker plastic. These containers must have increased rigidity relative to a container designed for hot-fill processing.

Rigidity of a container can be increased in other ways. For example, during a typical blow molding process, a heated piece of plastic is either extruded into a container mold or a pre-formed plastic tube (preform) is introduced into a mold. The perform can be made by, for example, injection molding or extrusion. Inside the blow mold, the pre-heated plastic can be further heated in order to soften it, and heated air blown into the container to stretch the softened plastic against the mold sidewalls, conforming to those sidewalls and thus shaping the container. The act of stretching a piece of plastic and conforming it to a mold mechanically induces biaxial orientation and crystallinity into the amorphous plastic. As described above, the oriented and crystallized plastic is more dense and rigid than the amorphous plastic.

The orientation and crystallinity of a plastic material can be increased in ways other than mechanical processing. The most common way of accomplishing this is through heat setting of the material. Heat setting is accomplished by heating the plastic material after molding. In one example of a heat set process, the mold is held at a slightly elevated temperature, for example, about 175° F. This can be accomplished by flowing heated water through channels within the mold. As a result of the mold walls being heated, when the plastic encounters the mold wall it is subject to a slightly higher temperature which induces some crystallinity and orientation of crystals in the container sidewalls. Other processes are known for heat setting. One example is described in the method of U.S. Pat. No. 6,485,669 to Boyd et al. According to the method disclosed in that patent, heated air is blown into the container after it is formed.

One drawback of heat-set processing can be the inducement of opacity into the container. Unoriented plastic such as PET is typically a clear substance. In the use of plastic containers, it is generally desirable to maintain the clarity of the container in order that a consumer can view the contents within the container. Unoriented PET is quite clear. However, as crystallinity and biaxial orientation is enhanced through, for example, a heat-set process, the opacity of the container is increased. As long as the crystallinity remains below about 30%, the container remains relatively clear. However, as the crystallinity increases, for example, to 30% and beyond, the opacity of the container increases. At approximately 30% crystallinity, this opacity is noticeable as a cloudiness in the container. As the crystallinity approaches values closer to 100%, the container can become substantially opaque and even take on a white appearance.

There thus remains a need in the art for methods of inducing crystallinity in a controllable manner. Desirable methods would produce crystallinities that would allow for strengthening of structural features of the container without unduly enhancing opacity. Furthermore, methods where crystallinity can be enhanced in regions of the container not visible to the consumer, for example, by limiting crystallinity to the base of the container, the clarity of the container can be maintained in the sidewalls or other parts where it is more desirable to have a clear container.

### SUMMARY OF THE INVENTION

In summary, a method for heat setting a portion of a blow molded container includes use of a blow mold that made up of at least a pair of sidewall mold halves and a base push up. Heated oil is circulated through the sidewall mold halves and the base pus up, where the oil circulated through the pair of sidewall mold halves is maintained at a temperature of at least about 225° F. and the oil circulated through the base push up is maintained at a temperature of at least about 275° F. An injection molded plastic preform is introduced into the blow mold and a container is blow molded. During the process the container is heat set and then ejected the container from the blow mold.

The oil circulated through the pair of sidewall mold halves is maintained at a temperature of about 275° F. The oil circulated through the base push up is maintained at a temperature of at least about 285° F., and can be 325° F. or higher. In a particular embodiment of the invention, the oil circulated through the pair of sidewall mold halves is maintained at a temperature of about 275° F. and the oil circulated through the base push up is maintained at a temperature of about 325° F. A container manufactured according to the invention can be filled with a food product and processed using a pasteurization or a retort method without unwanted deformation of the container.

In another aspect, the invention is a container made according to the above described method. The container according to this aspect includes a manufactured container, a filled container and a filled container that has been processed by a pasteurization or retort method.

In another aspect, a method for increasing crystallinity in at least a portion of a container includes circulating a heated non-aqueous fluid through a component of a blow mold, using the fluid to heat the component to a temperature of 200° C. or greater, blow molding a container from a plastic, and heat setting at least a portion of the container in contact with the heated component. The heated component can be, for example, a base push up. The base push up can be heated to a temperature greater than a temperature at which a sidewall mold half is heated. For example, the base push up can be heated to a temperature of 250° F. or greater, 285° F. or greater, or 325° F. or greater. Utilizing such a method, the crystallinity of the heated component can be increased to at least about 25%. The degree of crystallinity can be controlled so that it is increased to less than about 30%.

In a typical container prepared in a manner described herein, the plastic in the sidewall of the container can have a crystallinity of about 22-25% and the plastic in the base of the container can have a crystallinity of about 24-35%. In particular, the crystallinity in the base can be about 24%.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a side view of an exemplary embodiment of a container manufactured according to the present invention; and

FIG. 2 depicts a bottom perspective view of an exemplary embodiment of a container manufactured according to the present invention

### DETAILED DESCRIPTION OF THE INVENTION

The present invention is directed towards a method for producing a plastic container with enhanced crystallinity. The enhanced crystallinity induced according to the method can be limited to the base of the container. In most embodiments of the present invention, crystallinity is enhanced but maintained at a level that does not induce unintended opacity into the container structure.

In typical blow molding processes, hot water is circulated through the mold during blow molding. For example, channels can be cut into the mold sidewall and the base push up for the circulation of hot fluid. In most processes, the fluid used for heating the molds is water. The temperature attained in heat-setting is limited by the degree to which water can be heated, i.e. it is limited to the boiling point of water. Thus, the fluid circulating within the mold is generally at a temperature of 200° or less and, because it is circulating through the mold, is typically in the range of 150° to 180°. This is lower than the mold halves are held (about 275° F.), and limits the amount of heat induced crystallinity that can be achieved.

Water can be circulated through the mold in a particular pattern. For example, in the mold sidewalls, the water circulates through a series of channels in the mold which extend from the base towards the top of the mold, form a “U”-shaped channel through the top of the mold and circulate back down to the bottom of the mold. This up and down circulation of water can occur several times before the heated water eventually exits the mold for reheating and recirculation. In the base push up region of the mold, heated fluid is generally circulated in a spiral pattern, being injected near the center of the base and exiting after spiraling out towards the rim of the base push up. Utilizing such prior art techniques, and maintaining the container sidewall and base at about 180°, the crystallinity of both the container sidewalls and the base region of the container can be about 19%.

According to the present invention, the water which generally circulates to heat the mold is replaced by using hot circulating oil. By using oil to heat the molds, much higher base mold temperatures are achieved, leading to higher crystallinity values in the base. The use of oil has several advantages. First of all, heat transfer can be better controlled. This is because the temperature of the oil can be more easily maintained than the temperature of water. In particular, the oil circulating through the mold is heated to a temperature of greater than 200°, can be controlled to 250° or higher, including 285° 0or higher, 325°, or, if desired, higher than 325°.

In a particular embodiment of the present invention, the mold halves which form the container sidewalls are heated with water and the base push up mold heated with oil. According to this embodiment, the container sidewalls are heat-set during the blow molding process at a temperature of about 200°, whereas the base is heated to an elevated temperature of 200° or above. In other embodiments of the invention, both the sidewalls and the container base are heated with circulating oil to enhance orientation and crystallinity. For example, the container sidewalls and the base region can each be heated to greater than 200° or greater than 250°. For example, in one exemplary embodiment, the container sidewalls are heated at about 275°. Utilizing the present invention, the temperature of the base and the temperature of the sidewalls can differ in order to control crystallinity of the container in different regions. For example, the molds which form the container sidewalls can be heated to about 275° and the base heated at a higher temperature, for example, 325°.

In a particular method according to the present invention, a blow molded container is manufactured from polyethylene terephthalate from an injection molded preform, generally using standard blowmolding techniques. The water circulating in the mold halves and base push up portion is replaced by heated oil. The oil circulating through the sidewalls is maintained at a temperature of about 275° F., and the oil circulating through the base push up is maintained at a temperature of about 325° F. A container prepared according to this method can have a sidewall crystallinity of about 23-25% and an enhanced base crystallinity of about 24%. After blow molding, the container can be filled with a product, for example pickles or sauerkraut, and processed under pasteurization or retort conditions. A container so manufactured and processed is capable of withstanding distortion and base roll out.

The degree of crystallinity required to prevent base roll out and/or the oil temperature required to achieve a desired degree of crystallinity can vary depending on the design of the base and manufacturing conditions. For example, if the container is held in the mold for a longer period of time, a lower temperature may be required to achieve a particular degree of crystallinity. Additionally, different base designs may require varying degree of crystallinity in order to maintain structural integrity during processing. It is within the knowledge of the art to vary processing conditions, while utilizing the present invention, to achieve desired performance. Because the present invention allows for temperature control crystallinity in particular regions of the container, increases in crystallinity can be induced in areas of a container where deformation is problematic.

Other methods have been previously used to achieve higher heat set temperatures. For example, hot air can be blown into the container after it has formed, as disclosed in, for example, U.S. Pat. No. 6,485,669, identified above, and U.S. Pat. No. 6,585,124 to Boyd et al. There are several disadvantages to such methods, however. For example, the method requires an extra step with additional time for the container to remain in the mold. This slows down manufacturing lines, resulting in lower through-put and a decrease in efficiency. Further, although the air can be blown in a way that focuses on a limited area of the mold, it is difficult to limit the area where increased heat setting occurs. Thus, even though design features can be incorporated into the container to reduce crystallinity and the concomitant increase in opacity in areas where heat setting and opacity are not necessary or desired, e.g. the sidewalls, there is always some crystallinity and biaxial orientation induced in these other areas.

The present invention overcomes these disadvantages. For example, because the container walls, including the base, are subject to higher temperatures as blow molding occurs, sufficient heat setting is accomplished during the normal cycle time of the blow molding process. There is no need to slow down production for incorporation of an additional step. Also, according to the present invention, the heat set temperature of different regions of the container can be separately controlled. Therefore, increased heat setting and opacity can be limited to the area where it is desirable, i.e. the base, and the remainder of the container, where increased heat setting and clarity are desirable, i.e. the vertical sidewalls, can remain unchanged as compared to existing containers.

Containers prepared according to prior art methods can experience varying degrees of base roll out when subjected to pasteurization after filling. Improvements in base design can minimize roll out, but it can nonetheless remain a problem. Further, these alternative designs can result in thicker plastic and prevent or hamper efforts at ligthtweighting of containers. The ability to produce structurally sound lightweight containers is of paramount importance to the container manufacturing industry as well as to manufacturers and processors of food products packaged in plastic containers. Utilizing the present invention, suitably lightweight containers capable of withstanding the rigors of pasteurization and retort processing can be manufactured.

### EXAMPLE 1

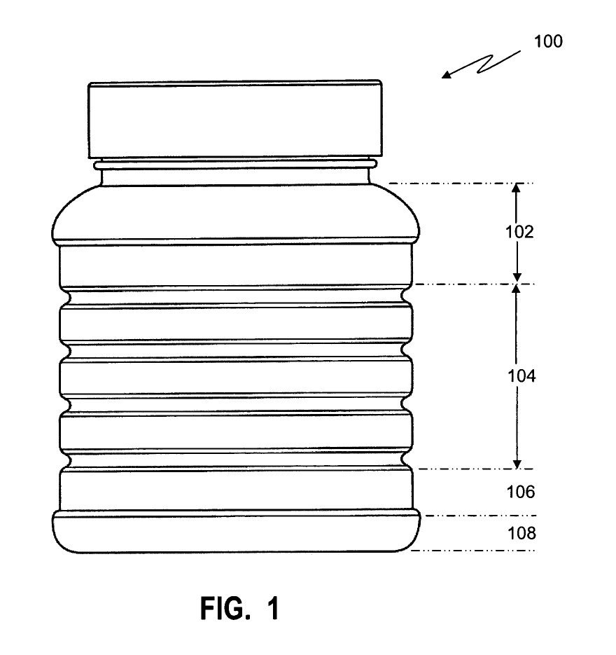

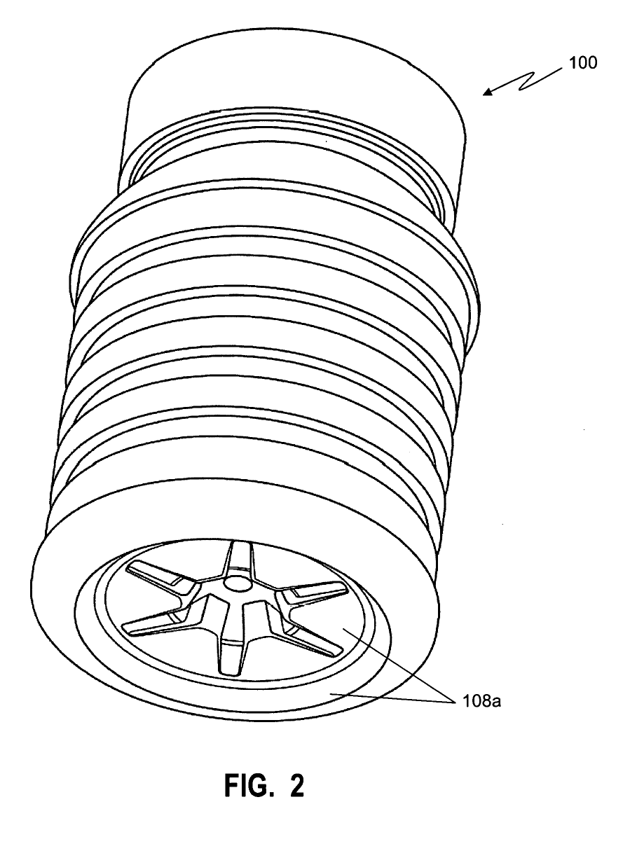

FIGS. 1 and 2 depict an exemplary container 100 prepared according to a method of the present invention. The container was blow molded from an injection molded preform manufactured from Heatwave® resin (available as CF746 from Voridian Corporation, a Division of Eastman Chemical Company, Kingsport, Tenn.), which has an amorphous density of 1.3291 g/cc, and a crystalline density of 1.4550 g/cc. The blow molding process was carried out using typical conditions and process parameters. The sidewall mold halves were held at a constant temperature of about 275° F., and the base temperature was varied as shown in Table 1.

After blowmolding, the container was cut into several sections represented of different regions of the sidewall and base: upper panel 102, midpanel 104, lower panel 106 and base 108. The base 108 included the underside of the container and the entire base push up region 108a. The crystallinity of the container in these regions was measured. The percent of crystallinity is defined as:

$$Crystallinity = \frac{ρ - {ρ}_{a}}{{ρ}_{c} - {ρ}_{a}}$$

where ρ is the measured density of the PET material; ρₐ is the density of pure amorphous PET material; and ρ_{c} is the density of pure crystalline material.

Table 1 presents exemplary experimental data obtained using various heat-set temperatures.

TABLE 1
Crystallinity Summary

| | | | | Crystal- | Crystal- |
|---|---|---|---|---|---|
| | | Density | Density St. | linity | linity |
| | Sample ID | Ave. | Dev. | Ave. | St. Dev. |
| 180° F. | Upper Panel | 1.360 | 0.001 | 24.6% | 0.9% |
| Base | Mid Panel | 1.358 | 0.001 | 22.9% | 0.9% |
| Temp | Lower Panel | 1.359 | 0.000 | 23.4% | 0.2% |
| | Base | 1.353 | 0.000 | 18.9% | 0.1% |
| 250° F. | Upper Panel | 1.360 | 0.000 | 24.8% | 0.1% |
| Base | Mid Panel | 1.359 | 0.000 | 24.1% | 0.2% |
| Temp | Lower Panel | 1.358 | 0.001 | 23.1% | 0.8% |
| | Base | 1.357 | 0.001 | 21.9% | 0.5% |
| 285° F. | Upper Panel | 1.361 | 0.000 | 25.0% | 0.3% |
| Base | Mid Panel | 1.361 | 0.000 | 25.0% | 0.3% |
| Temp | Lower Panel | 1.357 | 0.000 | 22.3% | 0.0% |
| | Base | 1.359 | 0.004 | 23.4% | 3.0% |
| 325° F. | Upper Panel | 1.359 | 0.000 | 24.1% | 0.2% |
| Base | Mid Panel | 1.360 | 0.000 | 24.5% | 0.3% |
| Temp | Lower Panel | 1.358 | 0.001 | 23.3% | 0.6% |
| | Base | 1.360 | 0.000 | 24.2% | 0.0% |

In Table 1, the first set of data is for a typical blowmolding process with heat setting. The sidewall and base temperatures are each maintained at about 180° F. In the remaining data, the sidewall is maintained at these typical temperatures, and the base temperature is increased as indicated. As can be seen by these data, the increase in temperature of the base has little affect on the crystallinity of the sidewall, even in the lower portion of the sidewall; the induced crystallinity in the container sidewall remains at approximately 23, ranging from about 22.9% to about 25%.

As the temperature of the base push up is increased during blow molding, the crystallinity in the base region is substantially enhanced when utilizing the present process. Utilizing a typical heat-setting process where base temperatures are maintained at about 180° F., the crystallinity of the sidewall varies from 23 to about 25% whereas the crystallinity in the base remains relatively low at about 19%. As the temperature at which the base push up portion of the mold is maintained increases, the crystallinity in the base is enhanced. For example, when the temperature of the base push up is held at about 250°, the crystallinity of the base increase from 18.9% to about 21.9%. Further increasing the temperature to about 285° results in an even higher crystallinity, about 23.4%. At base push up temperatures of about 325°, a crystallinity of about 24.2% can be obtained in the base region.

### Example 2

A container as shown in FIGS. 1 and 2, was blow molded according to the present invention, wherein the oil circulating within the sidewalls was maintained at about 275° F. and wherein the oil circulating within the base push up was maintained at about 325° F. After molding, the container was filled with pickles and brine and pasteurized using typical processing parameters. After processing, the container showed no visible signs of deformation, base roll-out or instability.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1) A method comprising:
providing a blow mold that comprises
a pair of sidewall mold halves; and
a base push up;
introducing an injection molded plastic preform into the blow mold;
circulating heated oil through the pair of sidewall mold halves and the base push up; wherein
the oil circulated through the pair of sidewall mold halves is maintained at a temperature of at least about 225° F.; and
the oil circulated through the base push up is maintained at a temperature of at least about 275° F.;
blow molding a container from the preform;
heat setting the container; and
ejecting the container from the blow mold.

2) The method of claim 1, wherein the oil circulated through the pair of sidewall mold halves is maintained at a temperature of about 275° F.

3) The method of claim 1, wherein the oil circulated through the base push up is maintained at a temperature of at least about 285° F.

4) The method of claim 1, wherein the oil circulated through the base push up is maintained at a temperature of about 325° F.

5) The method of claim 1, wherein the oil circulated through the pair of sidewall mold halves is maintained at a temperature of about 275° F. and the oil circulated through the base push up is maintained at a temperature of about 325° F.

6) A container manufactured according to the method of claim 1.

7) The method of claim 1, further comprising filling the container with a food product and processing the filled container using a pasteurization or a retort method.

8) A filled container manufactured according to the method of claim 7.

9) A method comprising
circulating a heated non-aqueous fluid through a component of a blow mold;
heating said component with said fluid to a temperature of 200° C. or greater;
blow molding a container from a plastic in said blow mold;
heat setting at least a portion of said container in contact with said component; and
thereby increasing crystallinity in said at least one portion.

10) The method of claim 9, wherein said component comprises a base push up.

11) The method of claim 10, wherein the base push up is heated to a temperature greater than a temperature at which a sidewall mold half is heated.

12) The method of claim 9, wherein the component is heated to a temperature of 250° F. or greater.

13) The method of claim 11, wherein the base push up is heated to a temperature of 285° F. or greater.

14) The method of claim 11, wherein the base push up is heated to a temperature of 325° F. or greater.

15) The method of claim 1, wherein the crystallinity is increased to at least about 25%.

16) The method of claim 1, wherein said crystallinity is increased to less than about 30%.

17) The method of claim 11, wherein the plastic in a sidewall of the container has a crystallinity of about 22-25% and the plastic in the base of the container has a crystallinity of about 24-35%.

18) A container comprising
a sidewall; and
a base;
wherein said container is heat set during blowmolding and sidewall has a crystallinity of about 22% to about 25%; and the base has a crystallinity of at least about 20%.

19) The container of claim 18, wherein the crystallinity of said base is about 24%.

20) The container of claim 19, wherein the crystallinity of said base is less than about 30%.
